(19) United States
(12) Patent Application Publication
(10) Pub. No.: US 2015/0079266 A1
(43) Pub. Date: Mar. 19, 2015

(54) GLUTINOUS MILLET NUTRITION MILK AND PREPARATION METHOD THEREOF

(71) Applicant: Institute of Millet Crops, Hebei Academy of Agriculture and Forestry Sciences, Shijiazhuang City (CN)

(72) Inventors: Zhiping DONG, Shijiazhuang City (CN); Jianzhang QUAN, Shijiazhuang City (CN); Jianfeng XIE, Shijiazhuang City (CN); Xiaolin HUANG, Shijiazhuang City (CN); Li DONG, Shijiazhuang City (CN); Jifang MA, Shijiazhuang City (CN); Lei LIU, Shijiazhuang City (CN); Zhiyong LI, Shijiazhuang City (CN); Hui BAI, Shijiazhuang City (CN); Yanbin ZHU, Shijiazhuang City (CN); Zhi ZENG, Shijiazhuang City (CN)

(21) Appl. No.: 14/549,070

(22) Filed: Nov. 20, 2014

Related U.S. Application Data
(63) Continuation of application No. PCT/CN2012/076064, filed on May 25, 2012.

(30) Foreign Application Priority Data
May 25, 2012 (CN) 201210165101.5

(51) Int. Cl. A23C 11/10

(52) U.S. Cl. CPC A23C 11/103; A23C 11/10
USPC 426/598; 426/487; 426/488

(57) ABSTRACT

The disclosure relates to a glutinous millet nutrition milk taking glutinous millet as raw material, and preparation process thereof, and particularly relates to a glutinous millet nutrition milk or compound glutinous millet nutrition milk taking the rust-proofing and glutinous foxtail millet variety of “Ji Chuang 1” glutinous millet as raw material and preparation process thereof. The glutinous millet nutrition milk or compound glutinous millet nutrition milk prepared by the method has the characteristics that the emulsion is stable, it will neither become aged nor coagulate or precipitate after long-term storage, and it does not need to add any anticoagulant stabilizer, which is more environmental friendly and healthy; its products utilize the rich nutrition of the millet, digests and absorbs easily, and tastes delicately.

### TECHNICAL FIELD

The present invention pertains to the cereal beverage processing technology in the food processing field, and particularly relates to a glutinous millet nutrition milk taking glutinous millet as raw material and preparation process thereof; and especially a glutinous millet nutrition milk or compound glutinous millet nutrition milk taking the rust-proofing and glutinous foxtail millet variety of “Ji Chuang 1” glutinous millet as raw material and preparation process thereof.

### BACKGROUND ART

Processing grain into beverages is an improvement in the coarse grain production technology and provides consumers with greater convenience, which is the significant difference between cereal beverage and the traditional beverage, the cereal beverage has transcended the basic demand of the traditional beverage of “meeting the taste and quenching thirst”, which effectively associates the consumption demand with the concept of “meal replacement”.

Cereal beverage will be one of the developing trend of beverage in the future, beverage products that human can directly drink produced through modern technology can not only keep enough nutrients in the cereal that are beneficial for the health of human body, but also tastes better, and it is more convenient to drink and can be absorbed more easily, it is one of the approach to solve the dietary nutritional imbalance of the urban residents in the modern fast-paced life; especially during the past 20 years, in the diet structure of residents in our country, percentages of intake of meat, eggs, milk and other animal food increased too much and too fast, while cereal food intake showed a trend of gradual decline; therefore, it can be seen that there is huge potential and business opportunities in the cereal beverage market. Most of the existing milk beverages are prepared with milk, soybean milk and peanuts and have similar contents of main ingredients and relatively high costs; milk beverages produced with millet has low cost, more comprehensive nutrition and broad development prospect.

Foxtail millet originates from China, and it is the traditional food crop raising the Chinese Nation. After being shelled, foxtail millet becomes millet which is nutritious and is easy to digest, and it is the preferred fine food for the older, the weaker, the sicker, especially for postpartum women and infants and young children to restore the body and grow healthily. In traditional Chinese medicine, it is considered that the millet tastes sweet and salty and is cold-natured (old millet tastes bitter and cold), and it has effects of regulating the middle warmer and benefiting the kidney, removing heat, and removing toxic substances; it can mainly treats deficiency-heat of the spleen and stomach, nausea and vomiting, abdominal distention and lack of appetite, diabetes, dysentery, and burn and scald. The Chinese Nation has a tradition to eat millet for a long time. At present, a large number of millet consumption is mainly in the form of millet congee. With the increase of pressure of human work and speeding up of human life pace, the traditional way of cooking congee can not satisfy the living needs of people, especially the urban residents, therefore, production of pure natural convenient millet nutrition milk is very necessary.

In general, most of common millets are non-glutinous and composed of the amylose, and they are mainly used for cooking millet congee which is eaten at once after being cooked. It coagulates after it cools, and it is layered and inedible after being reheated. The millet milk prepared by the common millets also coagulates after cooling, and it tends to become aged and layered and deteriorate after storage, so it need to add a lot of anticoagulant stabilizer, otherwise it can not be commercially produced; the present invention is made of glutinous millet, its main ingredient is amylopectin, the liquid milk made from the glutinous millet is stable emulsion at different temperatures, will not coagulate or become layered, and will not precipitate for long-term storage, and it does not need to add any anticoagulant stabilizer, which is more environmental friendly and healthy. Particularly, the “Ji Chuang 1” glutinous millet, which has the amylose content of only 1.22%, is a high-waxy-quality novel variety in existing glutinous millet which has the lowest amylose content. In addition, the average contents of vitamins B1, B2 in common varieties are 0.786 mg/kg and 0.121 mg/kg, respectively, while the contents of vitamins B1, B2 in “Ji Chuang 1” are 4.2 mg/kg and 1.0 mg/kg, respectively, which are 5.3 times and 8.3 times of the average contents; the average contents of iron, zinc, copper, and calcium in common varieties are 5.8 mg/kg, 2.57 mg/kg, 0.55 mg/kg, and 23.76 mg/kg, respectively, while the contents of iron, zinc, copper, and calcium in “Ji Chuang 1” are 30.1 mg/kg, 33.19 mg/kg, 5.86 mg/kg and 151.5 mg/kg, respectively, which are 5.2 times, 12.9 times, 10.7 times and 6.4 times of the average contents; the gel consistency and alkali spreading value are at a relatively high level. The millet milk made of the glutinous millet has more excellent quality.

In addition, millet has rich and balanced nutrition, the only shortcoming is that the lysine content is low, if some milk and bean products are added into the nutrition milk appropriately, the nutrition can become more balanced. Therefore, some milk and bean products can also be added into the raw materials of the glutinous millet nutrition milk of the present invention, in order to achieve the purpose of more rich and balanced nutrition. The product can pass on the food tradition of the Chinese Nation who loves eating millet, and avoid problems such as dyspepsia of people caused by drinking too much milk products.

### SUMMARY OF THE INVENTION

One purpose of the present invention is to provide a glutinous millet nutrition milk with comprehensive and balanced nutrition and without any additive.

The present invention relates to a preparation method of a glutinous millet nutrition milk, and a glutinous millet nutrition milk prepared by the method, the preparation method specifically comprises the following steps:

step 1, preparation of glutinous millet puree: (1) soaking: after carefully selected glutinous millet is washed in water at room temperature, water of 3 times the weight of the glutinous millet is added, and the glutinous millet is soaked in the water and taken out after 24 hours, then the glutinous millet and water are mixed according to the weight ratio of 1:8-9, grinded, and homogenized; (2) gelatinizing: heating gelatinization is carried out for 10-20 minutes at 70-85 DEG C; (3) grinding: first, coarse grinding of the completely gelatinized glutinous millet paste is carried out, and then colloid fine grinding is carried out for later use; wherein, said glutinous millet is “Ji Chuang 1” glutinous millet;

step 2, degassing and homogenizing: the glutinous millet puree is degassed through a vacuum degassing machine, with the vacuum degree of 0.8 MPa, and the center temperature of 90 DEG C; the temperature of the puree is required to be 40-50 DEG C before homogenizing, and a pressure of 16-18 MPa or colloid grinding is adopted for homogenizing;

step 3, sterilizing and cooling: the homogenized emulsion is sterilized for 15-40 minutes at the temperature of 121 DEG C and under the pressure of 0.12-0.18 MPa, and cooled rapidly to 38±4 DEG C to obtain the glutinous millet nutrition milk.

Preferably, the said glutinous millet nutrition milk is prepared with “Ji Chuang 1” glutinous millet.

The grinding in the step 1 can be carried out with a self-split grinding wheel; the sterilizing in the step 3 mainly aims to kill the pathogenic bacteria and putrefying bacteria that cause the glutinous millet milk to deteriorate.

A further purpose of the present invention is to provide a compound glutinous millet nutrition milk taking glutinous millet, milk, soybeans, or peanuts as raw materials, the preparation method of the compound glutinous millet nutrition milk specifically comprises the following steps:

step 1, preparation of glutinous millet puree: (1) soaking: after carefully selected glutinous millet is washed in water at room temperature, water of 3 times the weight of the glutinous millet is added, then the glutinous millet is soaked in the water and taken out after 24 hours, and the glutinous millet and water are mixed according to the weight ratio of 1:8-9, grinded, and homogenized; (2) gelatinizing: heating gelatinization is carried out at 70-85 DEG C for 10-20 minutes; (3) grinding: first, coarse grinding of the completely gelatinized glutinous millet paste is carried out, and then colloid fine grinding is carried out for later use; wherein, said glutinous millet is “Ji Chuang 1” glutinous millet;

preparation of milk: high-quality fresh milk is selected, and impurities and smell are removed by high temperature sterilization for later use;

preparation of the peanut puree: after carefully selected peanuts are washed in water, water of 3 times the weight of the peanuts is added at room temperature, the peanuts are soaked in the water and taken out after 12 hours, water is added according to the weight ratio of peanuts to water of 1:8-9, coat of the peanuts is removed, then the peanuts and water are grinded into a puree by a grinder and separated by filtration for later use;

preparation of the soybean puree: first the soybeans are soaked in 0.5% sodium bicarbonate solution of 3 times the weight of the soybeans for around 6-8 hours for softening, and impurities and skin of the soybeans are carried out; then the soybeans are treated with 110 DEG C saturated steam for 5-8 minutes for passivation and deodorization, soaked for 24 hours for softening, grinded into a puree according to the weight ratio of water to soybeans of 1:7-9, and separated by filtration, then colloid fine grinding is carried out to make the particle size around 4 microns for later use;

step 2, proportioning: 50-100 parts by weight of the glutinous millet puree, 0-50 parts by weight of the milk, 0-50 parts by weight of the peanut puree, and 0-50 parts by weight of soybean puree are mixed, provided that the amount of at least one of the milk, the soybeans and the peanut puree is not 0 part by weight;

step 3, degassing and homogenizing: the mixture of the step 2 is degassed through a vacuum degassing machine, with the vacuum degree of 0.8 MPa, and the center temperature of 90 DEG C; the temperature of the puree is required to be 40-50 DEG C before homogenizing, and a pressure of 16-18 MPa or colloid grinding is adopted for homogenizing;

step 4, sterilizing and cooling: the homogenized emulsion is sterilized for 15-40 minutes at the temperature of 121 DEG C and under the pressure of 0.12-0.18 MPa, and then cooled rapidly to 38±4 DEG C to obtain the glutinous millet nutrition milk.

The peanuts and soybeans of step 1 can be replaced by mung beans, red beans, black beans and all the other kinds of beans that have relatively high lysine content.

Preferably, the glutinous millet that is used for preparing compound glutinous millet nutrition milk is “Ji Chuang 1” glutinous millet;

Preferably, in the proportioning step, 50 parts by weight of the glutinous millet puree are mixed with 1-50 parts by weight of the peanut puree, and the amount of the milk and the soybean puree is 0 part by weight.

Preferably, in the proportioning step, 50 parts by weight of the glutinous millet puree are mixed with 1-50 parts by weight of the soybean puree, and the amount of the milk and the peanut puree is 0 part by weight.

Preferably, in the proportioning step, 50 parts by weight of the glutinous millet puree are mixed with 1-50 parts by weight of the milk, and the amount of the soybean puree and the peanut puree is 0 part by weight.

The raw materials adopted in the present invention are carefully selected raw materials, wherein the glutinous millet, beans and peanuts must be full particles, have uniform size, and have no mildew or deterioration, and can not have been damaged by worms, the color and odour should be normal, the impurity should be controlled within 1.0%, the aflatoxin content should be controlled to be less than or equal to 20 ug/kg, and the moisture content should be controlled to be less than or equal to 8.0%.

A further purpose of the present invention is to provide a glutinous millet milk prepared according to the above method.

When the present invention specifically uses “Ji Chuang 1” glutinous millet as its main ingredient, the amylose content is only 1.22%; in the case of no stabilizer added, the prepared glutinous millet nutrition milk or compound glutinous millet nutrition milk has the characteristics that the emulsion is stable, it will neither become aged nor coagulate or precipitate after long-term storage, and it does not need to add any anticoagulant stabilizer, which is more environmental friendly and healthy; its products utilize the rich nutrition of the millet, digests and absorbs easily, and tastes delicately; the nutrition is more balanced particularly when matched with milk protein and bean protein, it can pass on the food tradition of the Chinese Nation who loves eating millet, and it can replace the meal; this product is suitable for mass consumption and convenient for salaryman, and its low cost can broaden the range of consumer group, so it is suitable for large-scale development and can stimulate the foxtail millet industry development; the liquid milk made from the glutinous millet does not need to add any stabilizer, is stable emulsion at different temperatures, will not coagulate or become layered, and will not precipitate for long-term storage, it is pure natural with no additive, and it has smooth and delicate taste and rich millet flavour in the shelf life which is close to the relish and taste of freshly made millet congee.

### DETAILED DESCRIPTION OF THE INVENTION

### Embodiment 1

100 parts by weight of non-glutinous millet are weighed, soaked with water of 2 times the weight of the non-glutinous millet at room temperature, and taken out after 24 hours, then water is added according to the weight ratio of millet to water of 1:8, and the millet and the water are grinded with a self-split grinding wheel and homogenized for later use; heating gelatinization is carried out for 15 minutes at 70 DEG C; coarse grinding of the completely gelatinized millet paste is carried out, then colloid fine grinding is carried out; the millet puree after fine grinding is degassed through a vacuum degassing machine, with the vacuum degree of 0.8 MPa, and the center temperature of 90 DEG C; the temperature of the puree is lower than 50 DEG C before homogenizing, and a pressure of 18 MPa is adopted for homogenizing; the homogenized emusion is sterilized in high temperature and high pressure conditions (121 DEG C) for 20 minutes to kill the pathogenic bacteria and putrefying bacteria; then the emusion is taken out of the sterilizer and rapidly cooled to 38 DEG C to obtain the millet nutrition milk of the present invention.

### Embodiment 2

100 parts by weight of common glutinous millet are weighed, soaked with water of 2 times the weight of the common glutinous millet at room temperature, and taken out after 24 hours, then water is added according to the weight ratio of millet to water of 1:8, and the millet and the water are grinded with a self-split grinding wheel and homogenized for later use; heating gelatinization is carried out for 15 minutes at 70 DEG C; coarse grinding of the completely gelatinized millet paste is carried out, then colloid fine grinding is carried out; the millet puree after fine grinding is degassed through a vacuum degassing machine, with the vacuum degree of 0.8 MPa, and the center temperature of 90 DEG C; the temperature of the puree is lower than 50 DEG C before homogenizing, and a pressure of 18 MPa is adopted for homogenizing; the homogenized emusion is sterilized in high temperature and high pressure conditions (121 DEG C) for 20 minutes to kill the pathogenic bacteria and putrefying bacteria; then the emusion is taken out of the sterilizer and rapidly cooled to 38 DEG C to obtain the glutinous millet nutrition milk of the present invention.

### Embodiment 3

100 parts by weight of “Ji Chuang 1” glutinous millet are weighed, soaked with water of 2 times the weight of the “Ji Chuang 1” glutinous millet at room temperature, and taken out after 24 hours, then water is added according to the weight ratio of millet to water of 1:9, and the millet and the water are grinded with a self-split grinding wheel and homogenized for later use; heating gelatinization is carried out for 15 minutes at 70 DEG C; coarse grinding of the completely gelatinized millet paste is carried out, then colloid fine grinding is carried out; the millet puree after fine grinding is degassed through a vacuum degassing machine, with the vacuum degree of 0.8 MPa, and the center temperature of 90 DEG C; the temperature of the puree is lower than 50 DEG C before homogenizing, and a pressure of 18 MPa is adopted for homogenizing; the homogenized emusion is sterilized in high temperature and high pressure conditions (121 DEG C) for 15 minutes to kill the pathogenic bacteria and putrefying bacteria; then the emusion is taken out of the sterilizer and rapidly cooled to 38 DEG C to obtain the glutinous millet nutrition milk of the present invention.

### Embodiment 4

After carefully selected peanuts are washed in water, water of 3 times the weight of the peanuts is added, the peanuts are soaked in the water and taken out after 12 hours at room temperature, water is added according to the weight ratio of peanuts to water of 1:8, coat of the peanuts is removed, then the peanuts and water are grinded into a puree by a grinder and separated by filtration to form peanut emulsion; 50 parts by weight of “Ji Chuang 1” millet puree of the embodiment 3 obtained after fine grinding are mixed with 5 parts by weight of the peanut emulsion, the mixed millet puree is degassed through a vacuum degassing machine, with the vacuum degree of 0.8 MPa, and the center temperature of 90 DEG C; the temperature of the puree is required to be lower than 50 DEG C before homogenizing, and a pressure of 18 MPa is adopted for homogenizing; the homogenized emulsion is sterilized in high temperature and high pressure conditions (121 DEG C) for 15 minutes to kill the pathogenic bacteria and putrefying bacteria; then the emusion is taken out of the sterilizer and rapidly cooled to 38 DEG C to obtain the compound glutinous millet nutrition milk.

### Embodiment 5

50 parts by weight of “Ji Chuang 1” millet puree of the embodiment 3 obtained after fine grinding are mixed with 30 parts by weight of the peanut emulsion prepared in the embodiment 4, the mixed millet puree is degassed through a vacuum degassing machine, with the vacuum degree of 0.8 MPa, and the center temperature of 90 DEG C; the temperature of the puree is required to be lower than 50 DEG C before homogenizing, and a pressure of 18 MPa is adopted for homogenizing; the homogenized emulsion is sterilized in high temperature and high pressure conditions (121 DEG C) for 15 minutes to kill the pathogenic bacteria and putrefying bacteria; then the emusion is taken out of the sterilizer and rapidly cooled to 38 DEG C to obtain the compound glutinous millet nutrition milk.

### Embodiment 6

50 parts by weight of “Ji Chuang 1” millet puree of the embodiment 3 obtained after fine grinding are mixed with 50 parts by weight of the peanut emulsion prepared in the embodiment 4, the mixed millet puree is degassed through a vacuum degassing machine, with the vacuum degree of 0.8 MPa, and the center temperature of 90 DEG C; the temperature of the puree is required to be lower than 50 DEG C before homogenizing, and a pressure of 18 MPa is adopted for homogenizing; the homogenized emulsion is sterilized in high temperature and high pressure conditions (121 DEG C) for 15 minutes to kill the pathogenic bacteria and putrefying bacteria; then the emusion is taken out of the sterilizer and rapidly cooled to 38 DEG C to obtain the compound glutinous millet nutrition milk.

### Embodiment 7

First the soybeans are soaked in 0.5% sodium bicarbonate solution for around 6-8 hours for softening, and impurities and skin of the soybeans are removed; then the soybeans are treated with 110 DEG C saturated steam for 5-8 minutes, which can remove smell and complete the passivation and deodorization step, soaked for 24 hours for softening, grinded into a puree according to the weight ratio of water to soybeans of 1:7, and separated by filtration, then colloid fine grinding is carried out to make the particle size around 4 microns; 50 parts by weight of “Ji Chuang 1” millet puree of the embodiment 3 obtained after fine grinding are mixed with 10 parts by weight of the soybean puree, the mixed millet puree is degassed through a vacuum degassing machine, with the vacuum degree of 0.8 MPa, and the center temperature of 90 DEG C; the temperature of the puree is required to be lower than 50 DEG C before homogenizing, and a pressure of 18 MPa is adopted for homogenizing; the homogenized emulsion is sterilized in high temperature and high pressure conditions (121 DEG C) for 15 minutes to kill the pathogenic bacteria and putrefying bacteria; then the emusion is taken out of the sterilizer and rapidly cooled to 38 DEG C to obtain the compound glutinous millet nutrition milk.

### Embodiment 8

50 parts by weight of “Ji Chuang 1” millet puree of the embodiment 3 obtained after fine grinding are mixed with 25 parts by weight of the soybean puree prepared in the embodiment 7, the mixed millet puree is degassed through a vacuum degassing machine, with the vacuum degree of 0.8 MPa, and the center temperature of 90 DEG C; the temperature of the puree is required to be lower than 50 DEG C before homogenizing, and a pressure of 18 MPa is adopted for homogenizing; the homogenized emulsion is sterilized in high temperature and high pressure conditions (121 DEG C) for 15 minutes to kill the pathogenic bacteria and putrefying bacteria; then the emusion is taken out of the sterilizer and rapidly cooled to 38 DEG C to obtain the compound glutinous millet nutrition milk.

### Embodiment 9

50 parts by weight of “Ji Chuang 1” millet puree of the embodiment 3 obtained after fine grinding are mixed with 45 parts by weight of the soybean puree prepared in the embodiment 7, the mixed millet puree is degassed through a vacuum degassing machine, with the vacuum degree of 0.8 MPa, and the center temperature of 90 DEG C; the temperature of the puree is required to be lower than 50 DEG C before homogenizing, and a pressure of 18 MPa is adopted for homogenizing; the homogenized emulsion is sterilized in high temperature and high pressure conditions (121 DEG C) for 15 minutes to kill the pathogenic bacteria and putrefying bacteria; then the emusion is taken out of the sterilizer and rapidly cooled to 38 DEG C to obtain the compound glutinous millet nutrition milk.

### Embodiment 10

Fresh milk is filtered and sterilized using a pasteurization process, during the first time sterilizing, the temperature is controlled at 60 DEG C and the time is 15 s, then a high temperature-short time pasteurization (74 DEG C/18 s) is carried out to obtain sterilized milk emulsion; 50 parts by weight of “Ji Chuang 1” millet puree of the embodiment 3 obtained after fine grinding are mixed with 6 parts by weight of the milk emulsion, the mixed emusion is degassed through a vacuum degassing machine, with the vacuum degree of 0.8 MPa, and the center temperature of 90 DEG C; the temperature of the puree is required to be lower than 50 DEG C before homogenizing, and a pressure of 18 MPa is adopted for homogenizing; the homogenized emulsion is sterilized in high temperature and high pressure conditions (121 DEG C) for 15 minutes to kill the pathogenic bacteria and putrefying bacteria; then the emusion is taken out of the sterilizer and rapidly cooled to 38 DEG C to obtain the compound glutinous millet nutrition milk.

### Embodiment 11

50 parts by weight of “Ji Chuang 1” millet puree of the embodiment 3 obtained after fine grinding are mixed with 25 parts by weight of the milk emulsion of the embodiment 10, the mixed emusion is degassed through a vacuum degassing machine, with the vacuum degree of 0.8 MPa, and the center temperature of 90 DEG C; the temperature of the puree is required to be lower than 50 DEG C before homogenizing, and a pressure of 18 MPa is adopted for homogenizing; the homogenized emulsion is sterilized in high temperature and high pressure conditions (121 DEG C) for 15 minutes to kill the pathogenic bacteria and putrefying bacteria; then the emusion is taken out of the sterilizer and rapidly cooled to 38 DEG C to obtain the compound glutinous millet nutrition milk.

### Embodiment 12

50 parts by weight of “Ji Chuang 1” millet puree of the embodiment 3 obtained after fine grinding are mixed with 45 parts by weight of the milk emulsion of the embodiment 10, the mixed emusion is degassed through a vacuum degassing machine, with the vacuum degree of 0.8 MPa, and the center temperature of 90 DEG C; the temperature of the puree is required to be lower than 50 DEG C before homogenizing, and a pressure of 18 MPa is adopted for homogenizing; the homogenized emulsion is sterilized in high temperature and high pressure conditions (121 DEG C) for 15 minutes to kill the pathogenic bacteria and putrefying bacteria; then the emusion is taken out of the sterilizer and rapidly cooled to 38 DEG C to obtain the compound glutinous millet nutrition milk.

As for the appearance and processing quality of the obtained millet nutrition milk, though comprehensive analysis, it is considered that the millet nutrition milk obtained in the embodiment 3 has the best appearance and processing quality, the color of the obtained emulsion is bright yellow, the emulsion is thick and uniform, and it will neither become aged or layered nor precipitate after long-term storage.

| | raw material | color of | texture of | storage |
|---|---|---|---|---|
| | proportion | emulsion | emulsion | property |
| embodiment | 100 non-glutinous | light yellow | chaos | layered |
| 1 | millet | | | |
| embodiment | 100 common | yellow | thick | uniform |
| 2 | glutinous millet | | emulsion | |
| embodiment | 100 “Ji | bright | thick | uniform |
| 3 | Chuang 1” | yellow | emulsion | |
| | glutinous millet | | | |
| embodiment | 50 “Ji Chuang 1”: | bright | thick | uniform |
| 4 | 5 peanuts | yellow | emulsion | |
| embodiment | 50 “Ji Chuang 1”: | dark yellow | emulsion | uniform |
| 5 | 30 peanuts | | | |
| embodiment | 50 “Ji Chuang 1”: | brownish | dilute | precipitated |
| 6 | 50 peanuts | yellow | emulsion | |
| embodiment | 50 “Ji Chuang 1”: | yellow | emulsion | uniform |
| 7 | 10 soybeans | | | |
| embodiment | 50 “Ji Chuang 1”: | yellow | dilute | uniform |
| 8 | 25 soybeans | | emulsion | |
| embodiment | 50 “Ji Chuang 1”: | light yellow | dilute | uniform |
| | 45 soybeans | | emulsion | |
| embodiment | 50 “Ji Chuang 1”: | bright | thick | uniform |
| 10 | 6 milk | yellow | emulsion | |
| embodiment | 50 “Ji Chuang 1”: | yellow | dilute | uniform |
| 11 | 25 milk | | emulsion | |
| embodiment | 50 “Ji Chuang 1”: | yellow and | dilute | uniform |
| 12 | 45 milk | white | emulsion | |

The main nutritional quality of the obtained compound millet nutrition milk is as follows, though comprehensive analysis, it is considered that the millet and soybean compound nutrition milk obtained from the embodiment 8 has the highest protein content, and optimal nutritional value and cost.

| | | embodiment | | | embodiment | |
|---|---|---|---|---|---|---|
| | | 1 | embodiment | embodiment | 8 | embodiment |
| | | 100 | 3 | 5 | 50 “Ji | 11 |
| raw | unit | non- | 100 “Ji | 50 “Ji | Chuang 1”: | 50 “Ji |
| material | (in the | glutinous | Chuang | Chuang 1”: | 25 | Chuang 1”: |
| proportion | sample) | millet | 1” | 30 peanuts | soybeans | 25 milk |
| protein | % | 1.0 | 1.1 | 1.73 | 2.19 | 1.77 |
| fat | % | 0.368 | 0.41 | 2.13 | 0.98 | 1.34 |
| carbohydrate | % | 7.4 | 7.42 | 5.47 | 6.36 | 6.08 |
| dietary fiber | % | 0.46 | 0.617 | 0.57 | 1.06 | 0.57 |

Contents of the main vitamins and mineral substances in the obtained millet nutrition milk are shown in the table below, the “Ji Chuang 1” is relatively rich in the iron, zinc, copper and phosphorus contents and have relatively high nutritional value.

| | | embodiment 1 | |
|---|---|---|---|
| raw | | 100 | |
| material | | non-glutinous | embodiment 3 |
| proportion | unit/ | millet | 100 “Ji Chuang 1” |
| vitamin B1 | mg/kg | 0.386 | 0.42 |
| vitamin B2 | mg/kg | 0.121 | 0.1 |
| α | IU/kg | 0.59 | 0.58 |
| vitamin E | | | |
| Se | μg/kg | 4.2 | 3.6 |
| Fe | mg/kg | 0.58 | 3.01 |
| Zn | mg/kg | 0.257 | 3.319 |
| Cu | mg/kg | 0.055 | 0.586 |
| Ca | mg/kg | 2.376 | 1.515 |
| P | mg/kg | 268 | 340.74 |

Sensory evaluation of the obtained millet nutrition milk: 100 persons are organized to taste and compare the glutinous millet nutrition milks obtained from the above 12 embodiments, each person taste them anonymously in number order, the personal taste is divided into 4 levels, and the palatability index of each group is obtained, the millet milks mixed with milk that are obtained from the embodiments 10-12 have the highest score and the best taste, as is shown in the following table.

| | raw material | | | | |
|---|---|---|---|---|---|
| variety | proportion | excellent | good | passing | bad |
| embodiment 1 | 100 | 5 | 31 | 32 | 32 |
| | non-glutinous | | | | |
| | millet | | | | |
| embodiment 2 | 100 common | 82 | 13 | 5 | 0 |
| | glutinous millet | | | | |
| embodiment 3 | 100 “Ji Chuang | 90 | 8 | 2 | 0 |
| | 1” glutinous | | | | |
| | millet | | | | |
| embodiment 4 | 50 “Ji Chuang | 88 | 8 | 4 | 0 |
| | 1”: 5 peanuts | | | | |
| embodiment 5 | 50 “Ji Chuang | 83 | 13 | 4 | 0 |
| | 1”: 30 peanuts | | | | |
| embodiment 6 | 50 “Ji Chuang | 80 | 15 | 5 | 0 |
| | 1”: 50 peanuts | | | | |
| embodiment 7 | 50 “Ji Chuang | 89 | 8 | 3 | 0 |
| | 1”: 10 soybeans | | | | |
| embodiment 8 | 50 “Ji Chuang | 85 | 11 | 4 | 0 |
| | 1”: 25 soybeans | | | | |
| embodiment 9 | 50 “Ji Chuang | 82 | 13 | 5 | 0 |
| | 1”: 45 soybeans | | | | |
| embodiment | 50 “Ji Chuang | 90 | 9 | 1 | 0 |
| 10 | 1”: 6 milk | | | | |
| embodiment | 50 “Ji Chuang | 93 | 7 | 0 | 0 |
| 11 | 1”: 25 milk | | | | |
| embodiment | 50 “Ji Chuang | 96 | 4 | 0 | 0 |
| 12 | 1”: 45 milk | | | | |

The glutinous millet nutrition milk and preparation method thereof of the present invention have been described with reference to the specific embodiments. The raw materials and process conditions can be altered properly by those skilled in the art in light of the present disclosure to achieve corresponding other purposes without departing from the present invention, and all such similar substitutes and modifications apparent to those skilled in the art are deemed to be within the scope and concept of the invention.

1. A preparation method of a glutinous millet nutrition milk, comprising the following steps:
step 1, preparation of glutinous millet puree: (1) soaking: after carefully selected glutinous millet is washed in water at room temperature, water of 3 times the weight of the glutinous millet is added, and the glutinous millet is soaked in the water and taken out after 24 hours, then the glutinous millet and water are mixed according to the weight ratio of 1:8-9, grinded, and homogenized; (2) gelatinizing: heating gelatinization is carried out for 10-20 minutes at 70-85 DEG C; (3) grinding: first, coarse grinding of the completely gelatinized glutinous millet paste is carried out, and then colloid fine grinding is carried out for later use; wherein, said glutinous millet is “Ji Chuang 1” glutinous millet;
step 2, degassing and homogenizing: the glutinous millet puree is degassed through a vacuum degassing machine, with the vacuum degree of 0.8 MPa, and the center temperature of 90 DEG C; the temperature of the puree is required to be 40-50 DEG C before homogenizing, and a pressure of 16-18 MPa or colloid grinding is adopted for homogenizing;
step 3, sterilizing and cooling: the homogenized emulsion is sterilized for 15-40 minutes at the temperature of 121 DEG C and under the pressure of 0.12-0.18 MPa, and cooled rapidly to 38±4 DEG C to obtain the glutinous millet nutrition milk with an amylose content of only 1.22%.

2. The preparation method of claim 1, the grinding in the step 1 can be carried out with a self-split grinding wheel; the sterilizing in the step 3 mainly aims to kill the pathogenic bacteria and putrefying bacteria that cause the glutinous millet milk to deteriorate.

3. A preparation method of a compound glutinous millet nutrition milk by taking glutinous millet, milk, soybeans, or peanuts as raw materials, comprising the following steps:
step 1, preparation of glutinous millet puree: (1) soaking: after carefully selected glutinous millet is washed in water at room temperature, water of 3 times the weight of the glutinous millet is added, and the glutinous millet is soaked in the water and taken out after 24 hours, then the glutinous millet and water are mixed according to the weight ratio of 1:8-9, grinded, and homogenized; (2) gelatinizing: heating gelatinization is carried out at 70-85 DEG C for 10-20 minutes; (3) grinding: first, coarse grinding of the completely gelatinized glutinous millet paste is carried out, and then colloid fine grinding is carried out for later use; wherein, said glutinous millet is “Ji Chuang 1” glutinous millet;
preparation of milk: high-quality fresh milk is selected, and impurities and smell are removed by high temperature sterilization for later use;
preparation of peanut puree: after carefully selected peanuts are washed in water, at room temperature, water of 3 times the weight of the peanuts is added, the peanuts are soaked in the water and taken out after 12 hours, water is added according to the weight ratio of peanuts to water of 1:8-9, coat of the peanuts is removed, then the peanuts and water are grinded into a puree by a grinder and separated by filtration for later use;
preparation of the soybean puree: first the soybeans are soaked in 0.5% sodium bicarbonate solution of 3 times the weight of the soybeans for around 6-8 hours for softening, and impurities and skin of the soybeans are removed; then the soybeans are treated with 110 DEG C saturated steam for 5-8 minutes for passivation and deodorization, soaked for 24 hours for softening, grinded into a puree according to the weight ratio of water to soybeans of 1:7-9, and separated by filtration, then colloid fine grinding is carried out to make the particle size around 4 microns for later use;
step 2, proportioning: 50-100 parts by weight of the glutinous millet puree, 0-50 parts by weight of the milk, 0-50 parts by weight of the peanut puree, and 0-50 parts by weight of soybean puree are mixed, provided that the amount of at least one of the milk, the soybeans and the peanut puree is not 0 part by weight;
step 3, degassing and homogenizing: the mixture of the step 2 is degassed through a vacuum degassing machine, with the vacuum degree of 0.8 MPa, and the center temperature of 90 DEG C; the temperature of the puree is required to be 40-50 DEG C before homogenizing, and a pressure of 16-18 MPa or colloid grinding is adopted for homogenizing;
step 4, sterilizing and cooling: the homogenized emulsion is sterilized for 15-40 minutes at the temperature of 121 DEG C and under the pressure of 0.12-0.18 MPa, and then cooled rapidly to 38±4 DEG C to obtain the glutinous millet nutrition milk.

4. The preparation method of claim 3, wherein the peanuts and soybeans of step 1 are replaced by mung beans, red beans or black beans.

5. The preparation method of claim 3, wherein in the proportioning step, 50 parts by weight of the glutinous millet puree are mixed with 1-50 parts by weight of the peanut puree, and the amount of the milk and the soybean puree is 0 part by weight.

6. The preparation method of claim 3, wherein in the proportioning step, 50 parts by weight of the glutinous millet puree are mixed with 1-50 parts by weight of the soybean puree, and the amount of the milk and the peanut puree is 0 part by weight.

7. The preparation method of claim 3, wherein in the proportioning step, 50 parts by weight of the glutinous millet puree are mixed with 1-50 parts by weight of the milk, and the amount of the soybean puree and the peanut puree is 0 part by weight.

8. The glutinous millet nutrition milk or the compound glutinous millet nutrition milk obtained according to claim 1, having the characteristics that it is stable emulsion at different temperatures, and it will not coagulate, become layered, or precipitate for long-term storage, it is pure natural with no additive, and it has smooth and delicate taste and rich millet flavour in the shelf life which is close to the relish and taste of freshly made millet congee.

9. The glutinous millet nutrition milk or the compound glutinous millet nutrition milk obtained according to claim 3, having the characteristics that it is stable emulsion at different temperatures, and it will not coagulate, become layered, or precipitate for long-term storage, it is pure natural with no additive, and it has smooth and delicate taste and rich millet flavour in the shelf life which is close to the relish and taste of freshly made millet congee.
